(19) United States
(12) Patent Application Publication
(10) Pub. No.: US 2023/0256471 A1
(43) Pub. Date: Aug. 17, 2023

(54) Screening Apparatus

(71) Applicant: M&K Holdings (Ireland) Limited, Dungannon, County Tyrone (GB)

(72) Inventors: Nigel Rafferty, Dungannon, County Tyrone (GB); Desmond Rafferty, Dungannon, County Tyrone (GB)

(21) Appl. No.: 18/002,863

(22) PCT Filed: Jul. 19, 2021
(86) PCT No.: PCT/EP2021/070159

§ 371 Date: Dec. 22, 2022

(30) Foreign Application Priority Data
Jul. 22, 2020 (GB) 2011314.8

(51) Int. Cl. B07B 1/15; B07B 1/00; B65G 47/78

(52) U.S. Cl. CPC B07B 1/155; B07B 1/005; B65G 47/78

(57) ABSTRACT

The present invention relates to a screening apparatus (100) comprising a frame (10); a feed conveyor (20) mounted at one end of the frame and a screen (30) for accepting waste material from the feed conveyor, the waste material comprising fines and oversize material. The screen (30) is mounted on the frame (10) about a pivot axis and comprises a trough (32) with a top opening; and a plurality of driven elongate rotating members (40) disposed in an arc along one side of the trough and along at least a portion of the base of the trough (32) for causing circular or helical flow of the waste material within the trough. The trough (32) further comprises a base opening for discharging the fines material and an oversize material outlet for discharging the oversize material; and wherein the screen is mounted on the frame such that the elongate rotating members (40) are each independently perpendicular to the pivot axis.

The present invention relates to material handling equipment, in particular to screening apparatus for use in waste material handling, for example for use in the recycling industry.

### BACKGROUND TO THE INVENTION

Within the material handling industry there is a need for the ability to remove valuable material, for example stones, from other inert landfill material such as soil and muck.

Material collected from the demolition of buildings, excavations or by reclamation of rocky soil exhibits heterogeneous dimensions, typically contains debris of value combined with rubble, sand and other objects of small dimensions. There are a number of conventional mechanical screening methods used to separate these materials into multiple grades by particle size.

At the high throughput expensive end are washing plants. Washing plants process construction and civil engineering wastes into clean homogenous recycled product by washing the material to remove contaminants and extract silt and clay which bind the constituents together. The throughput can be very high, up to about 120 tonnes per hour. However, washing plants are very expensive to purchase, hire and operate. As well as being high cost, the whole process uses a lot of energy and water. Furthermore, the waste/dirty water is a big issue and has to be settled in settle ponds, often with the addition of chemicals to speed up the settling process.

On the cheaper, less efficient, side screening buckets may be used to separate material. A screening bucket must be attached to an excavating machine. The bucket typically has rotatable drums which effect screening, crushing or mixing of a material present in the bucket and at the same time deliver a screened, crushed or mixed material out of the bucket between or through the drums. Disadvantages with such buckets include the fact that the throughput is very low, usually about 20 tonnes per hour and the process is laborious for the driver of the excavator who has to frequently slew around between the different piles of material, for example between piles of stones and piles of fines material.

It is therefore an object of the present invention to provide a screening apparatus for inert landfill material which alleviates the above disadvantages and/or provides a suitable alternative.

### SUMMARY OF THE INVENTION

The present invention relates to apparatus for use in screening and conveying waste material and which allows oversize material to self-discharge.

Accordingly, a first aspect of the present invention is a screening apparatus comprising:
a frame;
a feed conveyor mounted at one end of the frame; and
a screen for accepting waste material from the feed conveyor, the waste material comprising fines and oversize material,
wherein the screen is mounted on the frame about a pivot axis and comprises:
   a trough with a top opening; and
   a plurality of driven elongate rotating members disposed in an arc along one side of the trough and along at least a portion of the base of the trough for causing circular or helical flow of the waste material within the trough,
wherein the trough further comprises a base opening for discharging the fines material and an oversize material outlet for discharging the oversize material; and

wherein the screen is mounted on the frame such that the elongate rotating members are each independently perpendicular to the pivot axis.

The curved placement of the elongate rotating members results in the waste material being flipped and tossed which increases the screening efficiency and causes any sticky material to break up.

The screen is pivotable about the pivot axis such that the inlet end of the screen may be raised or lowered.

In a preferred embodiment, the pivot axis is at the outlet end of the screen. However, this is not to be considered limiting and the pivot axis may alternatively be located at the inlet end or anywhere between the inlet and outlet ends of the screen.

In a preferred embodiment, the screen is pivotally mounted on the frame such that at least a portion of the top opening of the trough is located beneath the feed conveyor. Alternatively, or additionally, the screening apparatus further comprises a static feed plate between the feed conveyor and the screen such that the waste material to be screened falls from the feed conveyor onto the static feed plate, bounces or slides off the plate and then drops into the screen.

The screening apparatus according to the invention is preferably static for placement above containment bays for collecting the discharged fines and oversize material. Such containment bays may be made of shuttered concrete, or manufactured from steel, concrete blocks and the like. However, rather than being static, the screening apparatus may be provided with any one or more of wheels, tracks and hooklift.

The oversize material outlet is preferably at the front of the trough, i.e. at the opposite end of the screen to the feed conveyor. Alternatively, the oversize material outlet is at a side of the trough, close to the front of the trough. In a particularly preferred embodiment, the trough comprises two oversize material outlets, for example one at the front and one at the side, wherein each oversize material outlet independently may be plated off in order to change direction of outlet flow of oversize material.

In a preferred embodiment, the rotating members are interconnected. Alternatively, the rotating members are each independently driven.

There are preferably at least three rotating members, particularly preferably from about 4 to about 12, e.g. 6.

In a preferred embodiment, the rotating members rotate in the range of from about 90 to about 200 rpm. However, this is not considered to be limiting and other speeds are considered to be within the scope of the invention. The faster the rpm, the less time the fines material has to settle and fall through the base opening of the trough and the finer the material. Particularly preferably, the rotating members rotate at variable speed.

The rotating members are preferably actuated by a motor and mechanical transmission. The motor may be hydraulic or electric, for example a variable speed electric motor. In the embodiment wherein the rotating members are interconnected, a first toothed pulley is typically keyed onto the output shaft of the motor and a plurality of second toothed pulleys are keyed onto respective ends of the rotating members outside of the trough and coupled to the first toothed pulley by means of chains.

Each rotating member preferably comprises a shaft and a plurality of mutually parallel blades.

Particularly preferably, each blade independently has a plurality of radial extensions which act on the material during the rotation thereof, particularly preferably curved radial extensions. For example, the blades may be polyurethane stars such as curved, hexagonal, circular, or straight legged stars. However, this is not to be considered limiting and other materials and shapes are encompassed within the scope of the invention.

In a preferred embodiment, the screen further comprises a feed inlet for accepting the waste material from the feed conveyor such that the feed inlet is beneath the feed conveyor, particularly preferably wherein the feed inlet is in the form of a chute, e.g. a three-sided chute.

Alternatively, or additionally, the screen comprises a first plurality of driven elongate rotating members disposed in a first arc along one side and along at least a portion of the base of the trough and a second plurality of driven elongate rotating members disposed in a second arc along the other side of the trough and along at least a portion of the base of the trough.

In a particularly preferred embodiment, the first plurality of rotating members run in the opposite direction to the second plurality of rotating members. For example, if the shafts of the first plurality of driven elongate rotating members operate in the clockwise direction, shafts of the second plurality of driven elongate rotating members operate in the anti-clockwise direction and vice versa.

The screen is pivotally mounted to the frame such that the angle may be altered to dictate retention time of the waste material within the trough. For example, the screen may be mounted at 0 degrees with respect to the frame. Alternatively, the screen may be pivoted along the pivot axis such that the screen is angled and mounted with the inlet end lower than the outlet end in order to retain the material for longer, e.g. with the outlet end upwards up to about 2.5 degrees. The larger the angle, the more time the material is on the screen. Alternatively, the screen may be pivoted along the pivot axis such that the screen is angled and mounted with the inlet end higher than the outlet end, e.g. the outlet lowered up to about 15 degrees, such that the material remains on the screen for a shorter time. In this embodiment, the larger the angle, the less time the material is on the screen.

In a preferred embodiment, the screening apparatus further comprises a ram assembly to alter the pivot angle of the screen with respect to the frame. The ram assembly may be directly attached to the screen or may be located elsewhere on the screening apparatus. Alternatively, the screen could be lifted, e.g. using a crane, and pinned in position.

In a preferred embodiment, the screening apparatus further comprises one or more conveyors to collect and stockpile screened material.

Additionally, or alternatively, the screening apparatus preferably comprises a plurality of screens in series, particularly preferably two screens in series. The plurality of screens may be in line or stepped with respect to each other. In these embodiments only the first screen has a feed inlet. Both embodiments enable an increase in the screening length. When placed in line, the oversize material outlet is preferably at a side of the second trough rather than at the front.

In addition to enabling increased screen length, the screens in series may also be used to give additional product sizes, i.e., the first screen allowing fines material of a diameter up to about 10 mm through its base opening, the second allowing fines material of a diameter up to about 25 mm through its base opening and the remaining material exiting the machine through the oversize material outlet.

In order to enable the screen to be removed from the screening apparatus for ease of maintenance of the screen, the screen is preferably removably mounted to the frame. For example, the screen preferably slides with respect to the frame for removal. The feed conveyor is preferably also slidably mounted to the frame such that it can be moved out of the way to facilitate removal of the screen.

### BRIEF DESCRIPTION OF THE DRAWINGS

Certain preferred embodiments of the present invention will now be described, by way of example only, with reference to the accompanying drawings in which:

FIG. 1 shows a perspective view of a preferred embodiment of the screening apparatus according to the invention;

FIG. 2a shows a perspective view of the screen of the screening apparatus of FIG. 1;

FIG. 2b shows a plan view of the screen of FIG. 2a;

FIG. 2c shows an end view of the screen of FIG. 2a;

FIG. 3 shows a preferred elongate rotating member of the screen of the screening apparatus of FIG. 1;

FIG. 4a shows a side view of two inline screens in series;

FIG. 4b shows a side view of two stepped screens in series;

FIG. 5a shows a side view of the screening apparatus of FIG. 1 with the screen at zero degrees;

FIG. 5b shows an enlarged view of the ram assembly used in FIG. 5a;

FIG. 6a shows a side view of the screening apparatus of FIG. 1 with the screen tilted;

FIG. 6b shows an enlarged view of the ram assembly used in FIG. 6a;

FIG. 7 shows a perspective view of an alternative preferred embodiment of the screening apparatus according to the invention;

FIG. 8 shows a plan view of the screening apparatus of FIG. 7;

FIG. 9 shows a perspective view of the screen of the screening apparatus of FIG. 7;

FIG. 10 shows another perspective view of the screening apparatus of FIG. 7;

FIG. 11 shows an end view of the screen of FIG. 7;

FIG. 12 shows an outlet end view of the screen of FIG. 7;

FIG. 13a shows a plan view of the screen of FIG. 7;

FIG. 13b shows a sectional view along line A-A in FIG. 13a;

FIG. 13c shows a sectional view along line B-B in FIG. 13a;

FIG. 14a shows a side view of the screen of FIG. 9 when mounted upwards 7 degrees;

FIG. 14b shows a perspective view of the screen of FIG. 14a;

FIG. 15a shows a side view of the screen of FIG. 9 when mounted upwards 3 degrees;

FIG. 15b shows a perspective view of the screen of FIG. 15a; and

FIG. 16 shows a perspective view of another alternative preferred embodiment of the screening apparatus according to the invention.

### DETAILED DESCRIPTION

Various embodiments of the present invention will be described in detail with reference to the drawings, where like reference numeral represent like parts and assemblies throughout the several views.

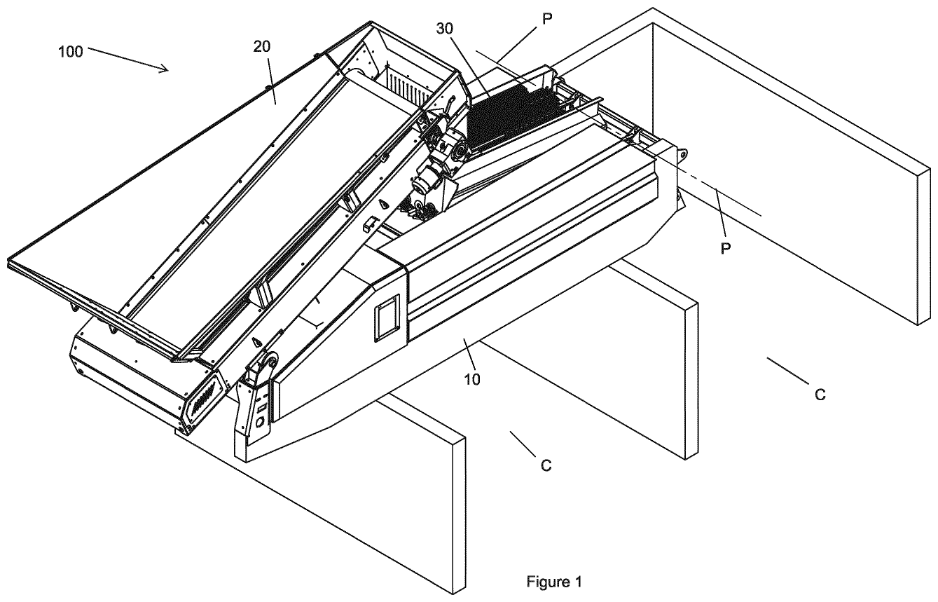

Referring to the drawings, FIG. 1 shows a preferred screening apparatus according to the invention, generally referred to herein by reference numeral 100. As shown, screening apparatus 100 comprises frame 10, feed hopper 20 mounted at one end of frame 10 and screen 30 pivotally mounted on frame 10 about pivot axis P. In the preferred embodiment shown in FIG. 1, screening apparatus 100 is static and placed on containment bays C for collecting discharged fines and oversize material. However, the screening apparatus according to the invention may alternatively be provided with any one or more of wheels, tracks and hooklift.

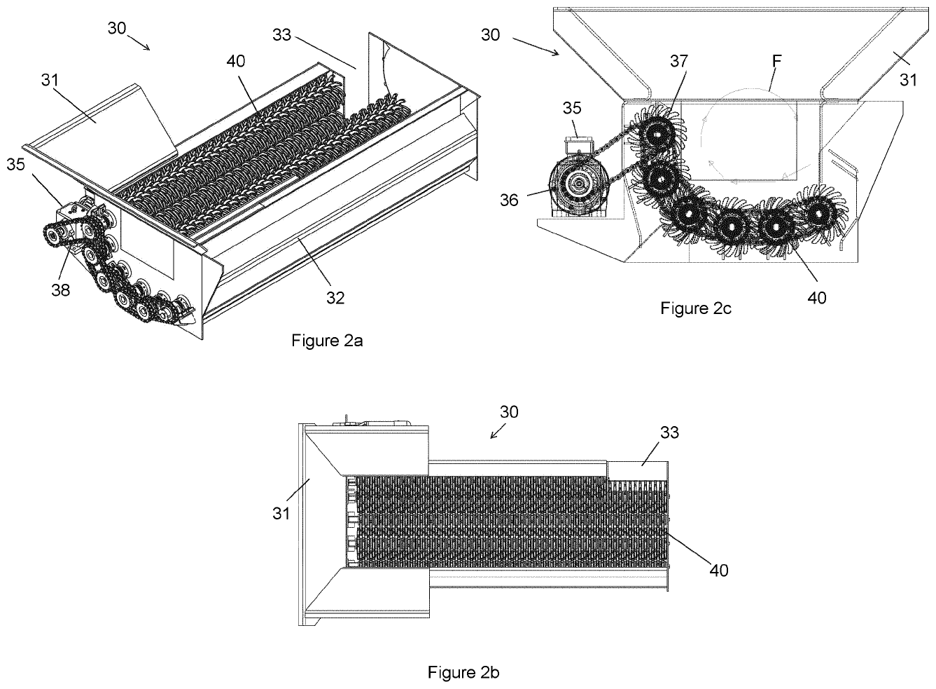

As shown in FIGS. 2a to 2c, screen 30 comprises feed inlet 31 for accepting waste material from hopper 20, trough 32 and six interconnected driven elongate rotating members 40 disposed in an arc along one side and the base of trough 32. Arrows F in FIG. 2c show the direction of flow of the material within screen 30 during use when angled with respect to frame 10.

Screen 30 is mounted on frame 10 such that feed inlet 31 is located beneath the output end of feed hopper 20.

As shown in the preferred screen of FIGS. 2a to 2c, feed inlet 31 is in the form of a three-sided chute.

As well as being open at the top for accepting waste material from feed inlet 31 and open at the base to allow fine material to be discharged, trough 32 is provided with outlet 33 for discharging oversize material. Oversize outlet 33 is shown at the front of trough 32 in the Figures, i.e. at the opposite end of screen 30 to feed inlet 31. Alternatively, an oversize material outlet (not shown) may be at a side of trough 32, close to the front of the trough, or both, wherein each oversize material outlet independently may be plated off in order to change direction of outlet flow of oversize material.

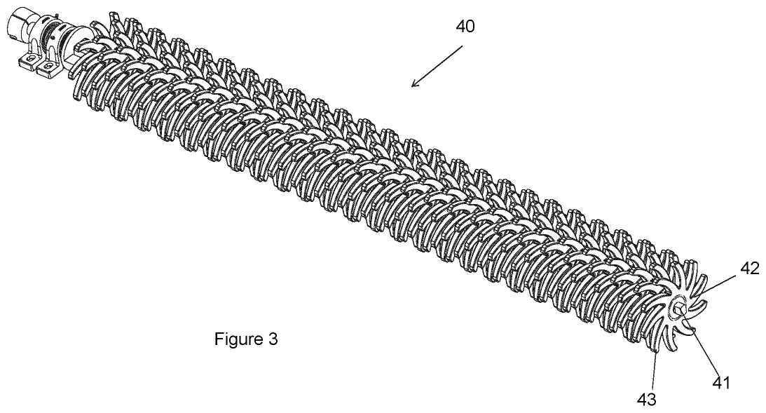

Each of interconnected driven elongate rotating members 40 has a shaft 41 and a plurality of mutually parallel and overlapping star shaped agitations 42. An example of rotating member 40 is shown in FIG. 3. Each star shaped agitator 42 independently has a plurality of radial extensions 43 which act on the material during the rotation thereof. The star shaped agitator can be manufactured from any suitable material such as toughened steel, mild steel and hard wearing plastics material such as polyurethane.

As can be seen from FIG. 1, shafts 41 are each independently perpendicular to pivot axis P by which screen 30 is pivotally mounted on frame 10.

Rotating members 40 are actuated by a motor, for example variable speed electric motor 35. A first toothed pulley 36 is keyed onto the output shaft of motor 35 and a plurality of second toothed pulleys 37 are keyed onto respective ends of rotating members 40 outside of trough 32 and coupled to first toothed pulley 36 by means of chains 38.

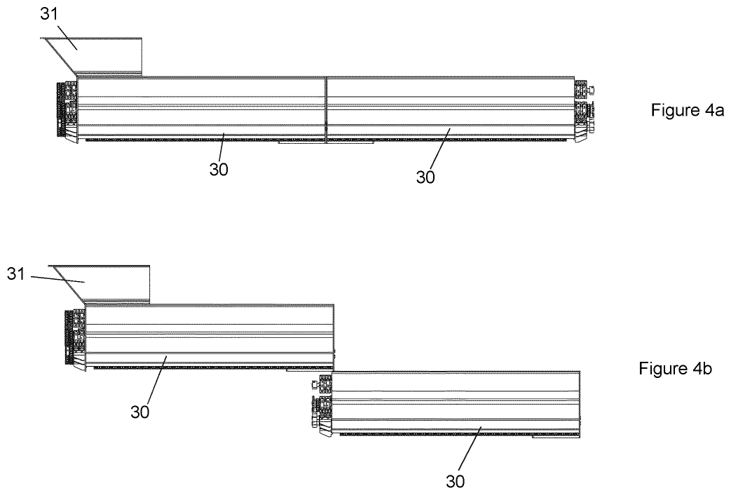

As shown in FIGS. 4a and 4b, two screens 30 may be combined in series, either in line as in FIG. 4a or stepped with respect to each other as in FIG. 4b. In these embodiments only the first screen is provided with feed inlet 31. When placed in line, the oversize material outlet is at the side of the second trough.

Combining screens in series can be used to increase the screening length, or, if different speeds or blades are used to give more products of differing sizes, e.g. fines material with a diameter less than 10 mm, material with a diameter of from about 10 mm to about 25 mm and oversize material with a diameter of from 25 mm. However, these diameters are not to be considered limiting.

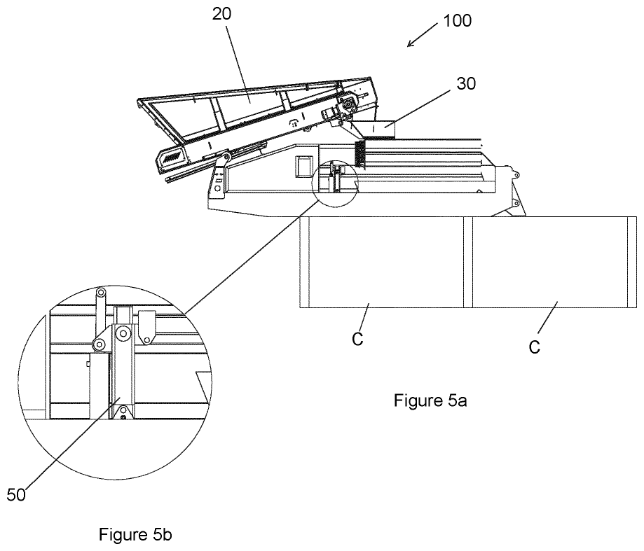

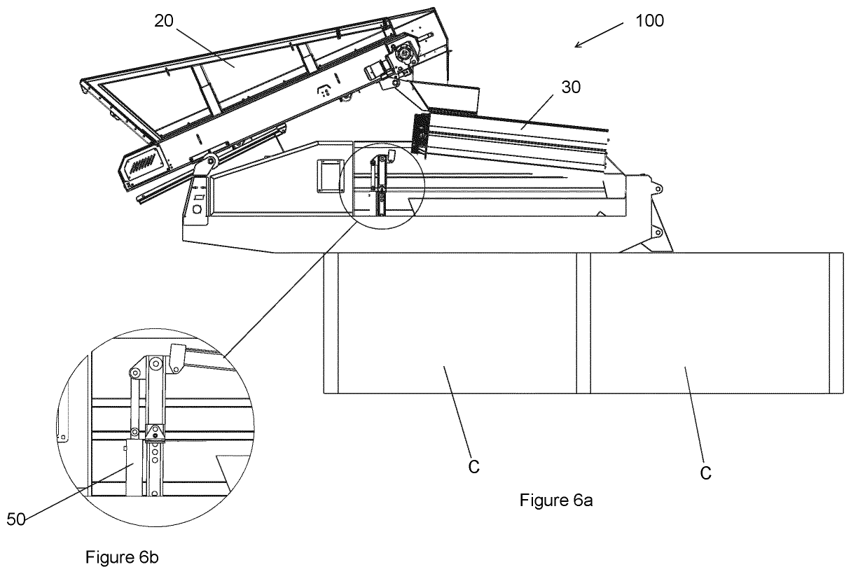

As shown in FIGS. 5a, 5b, 6a and 6b screening apparatus 100 further comprises ram assembly 50 to alter the pivot angle of screen 30 with respect to frame 10, i.e. along pivot axis P, to allow alteration of the retention time of the waste material within trough 32. For example, screen 30 may be mounted at 0 degrees as in FIG. 5a, angled such that the outlet 33 is raised to retain the material for longer (not shown) or angled downwards such that outlet 33 is lowered, e.g. by about 6 degrees as in FIG. 6a, such that the material remains on screen 30 for a shorter time.

In other words, in use of the screening apparatus, oversize material keeps going around blades 42 of rotating members 40 but does not move towards outlet 33 until screen 30 is pivoted such that screen 30 is angled downwards. Gravity then moves the oversize material toward oversize material outlet 33.

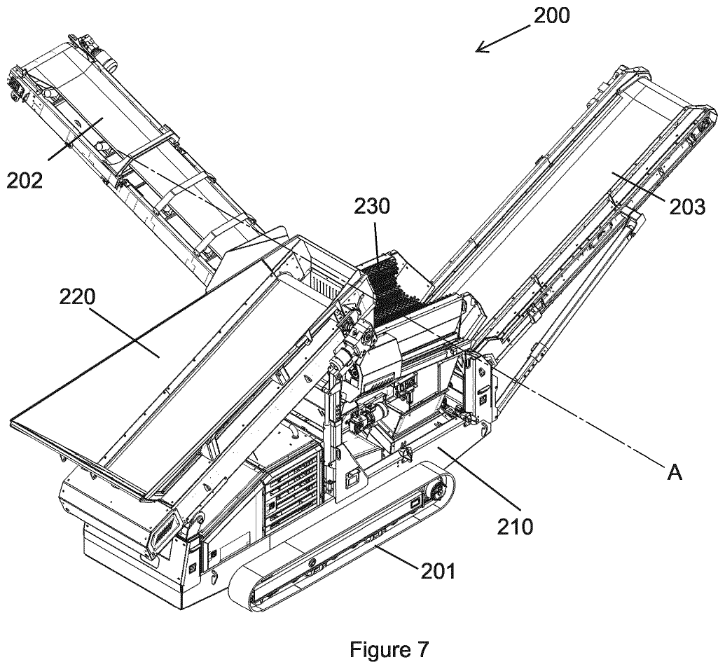

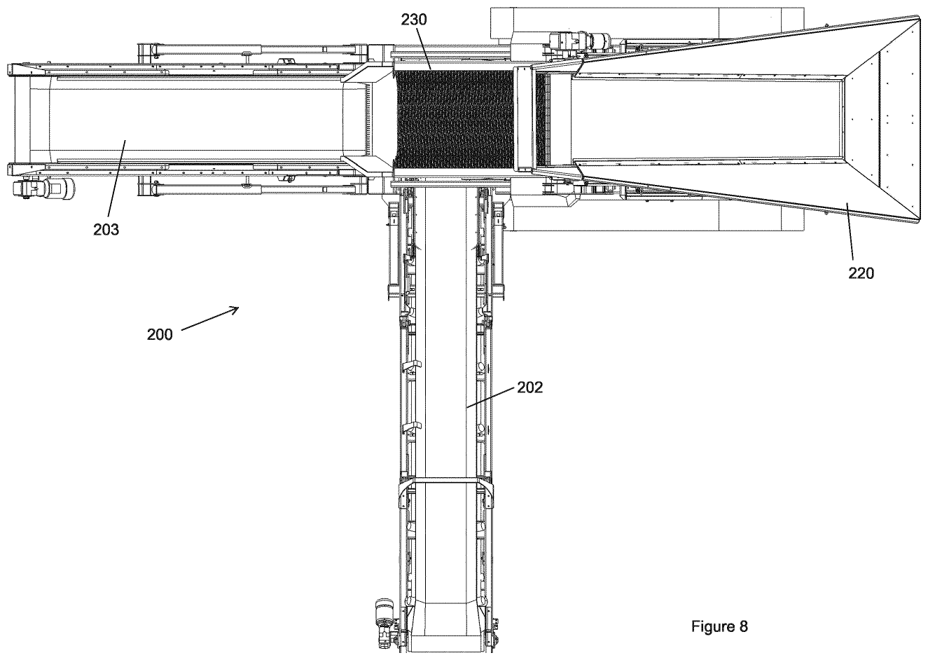

FIGS. 7 and 8 show an alternative preferred screening apparatus according to the invention, generally referred to herein by reference numeral 200. As shown, screening apparatus 200 comprises frame 210, feed hopper 220 mounted at one end of frame 210 and screen 230 pivotally mounted on frame 210 about pivot axis A. In the preferred embodiment shown in FIGS. 7 and 8, screening apparatus 200 is mobile and further comprises tracks 201. Additionally, screening apparatus 200 further comprises conveyor 202 to collect and stockpile screened fines material and conveyor 203 to collect and stockpile screened oversize material.

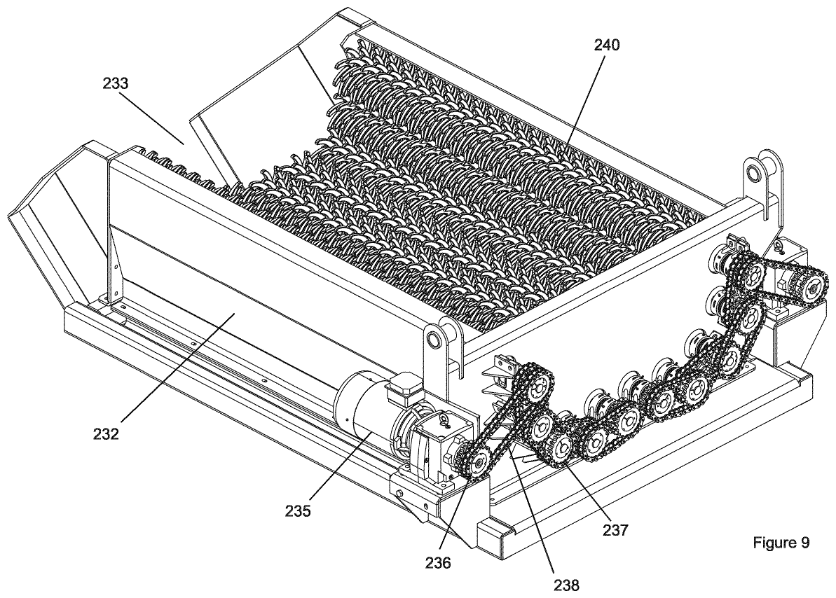

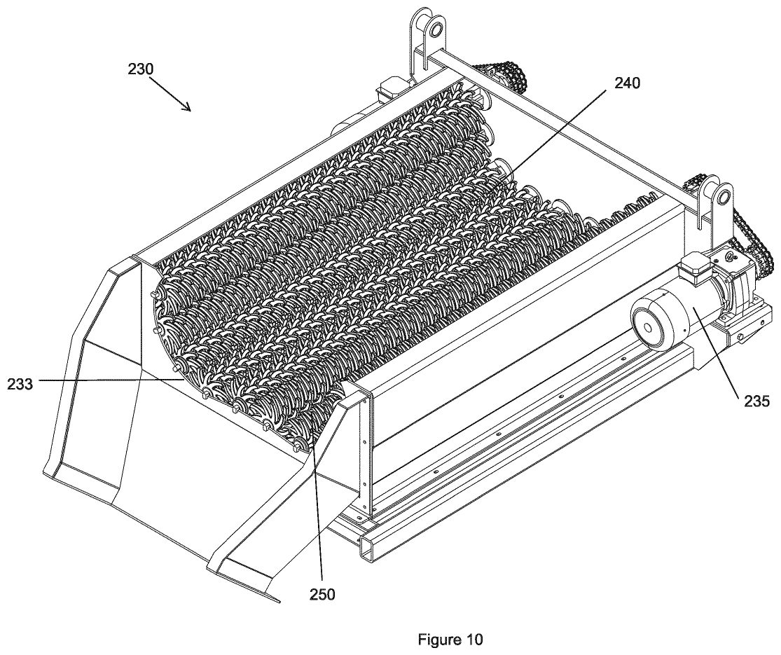

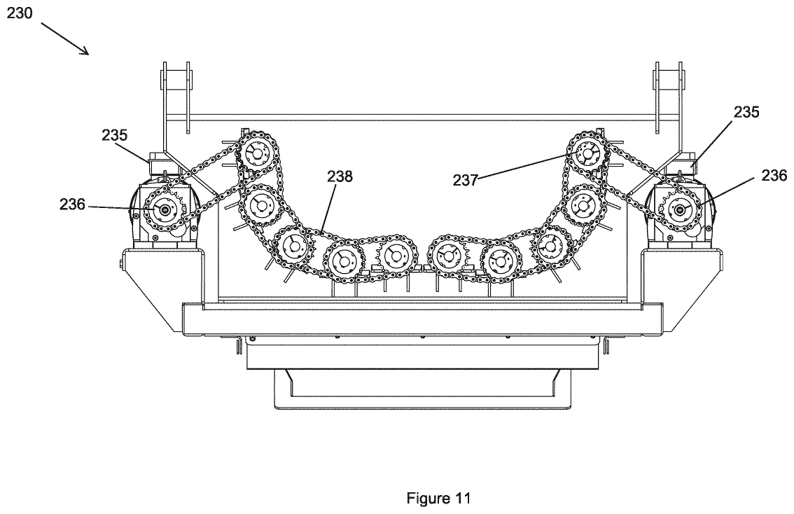

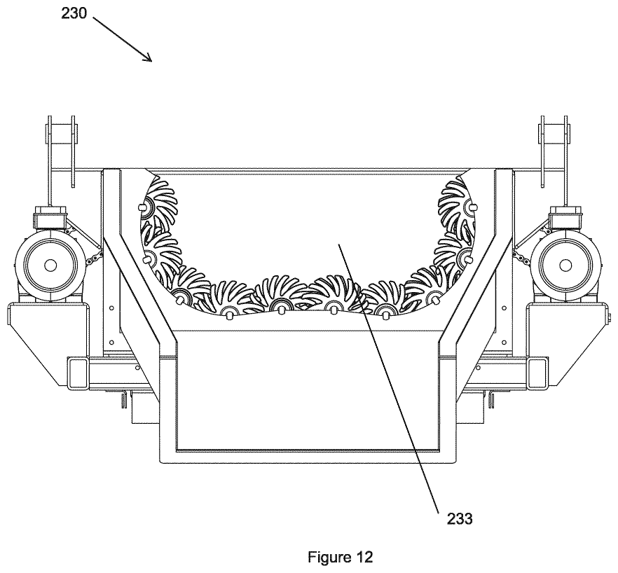

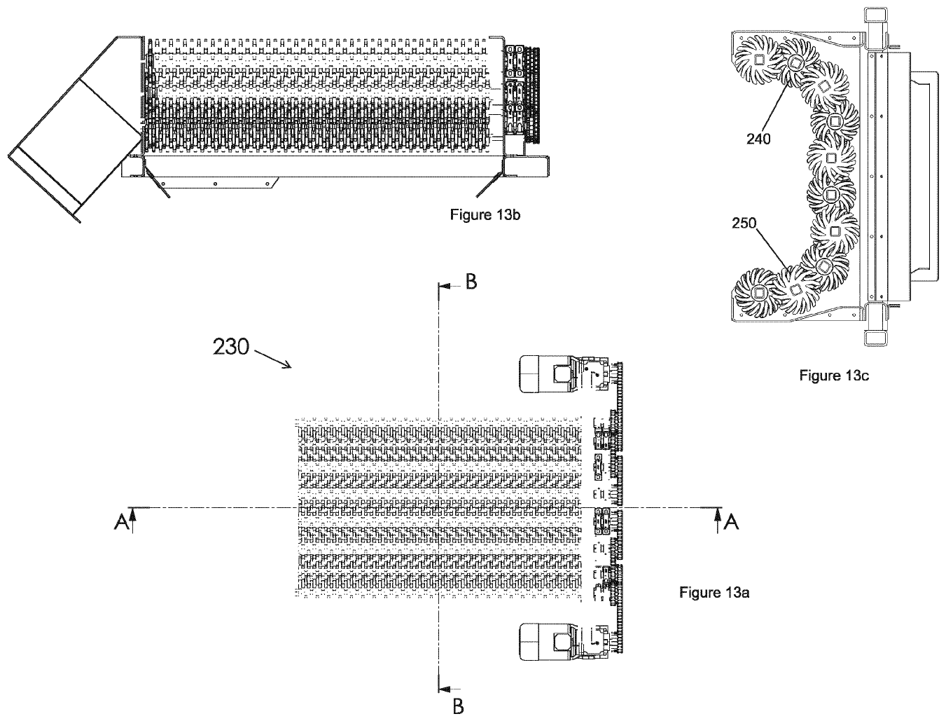

As shown in FIGS. 9 to 13c, screen 230 comprises trough 232, five interconnected driven elongate rotating members 240 disposed in an arc along one side of trough 232 and toward the middle of the base of trough 232 and five interconnected driven elongate rotating members 250 disposed in an arc along the other side of trough 232 and toward the middle of the base of trough 232.

As well as being open at the top for accepting waste material from hopper 220 and open at the base to allow fine material to be discharged, trough 232 is provided with outlet 233 for discharging oversize material. Oversize outlet 233 is shown at the front of trough 32 in the Figures, i.e. at the opposite end of screen 230 to hopper 220. Alternatively, an oversize material outlet (not shown) may be at a side of trough 232, close to the front of the trough, or both, wherein each oversize material outlet independently may be plated off in order to change direction of outlet flow of oversize material.

Screen 230 is mounted on frame 210 such that at least a portion at least a portion of the top opening of trough 232 is located beneath the outlet end of feed hopper 220 and the elongate rotating members 240, 250 are each independently perpendicular to pivot axis A.

In order to enable screen 230 to be removed from the screening apparatus for ease of maintenance of the screen, screen is removably mounted to frame 210 such that screen 230 slides with respect to frame 210 for removal therefrom.

Each of interconnected driven elongate rotating members 240, 250 is identical to rotating member 40 shown in FIG. 3.

Rotating members 240 run in the opposite direction to rotating members 250, i.e. the shafts of rotating members 240 operate in the clockwise direction and the shafts of rotating members 250 operate in the anti-clockwise direction.

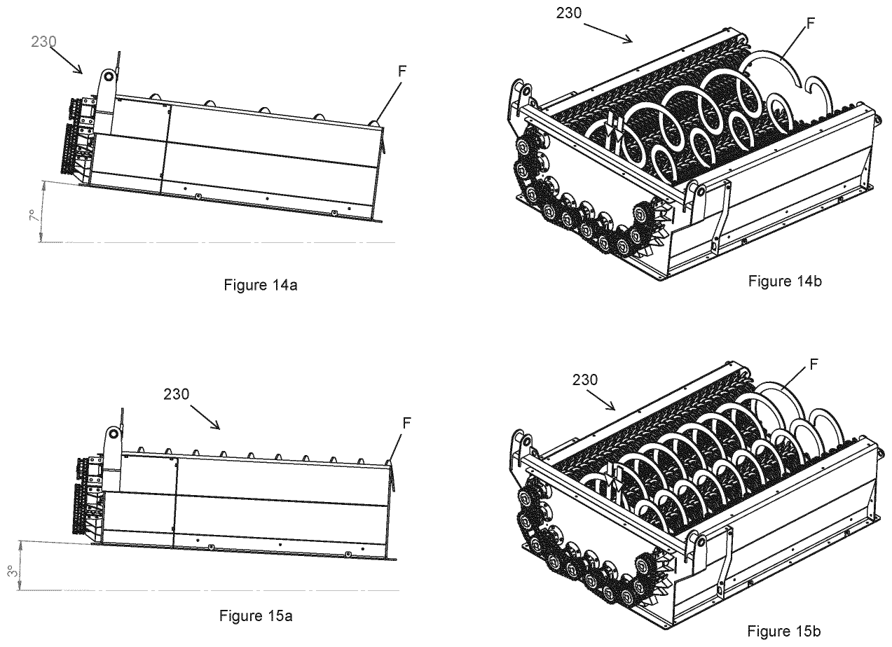

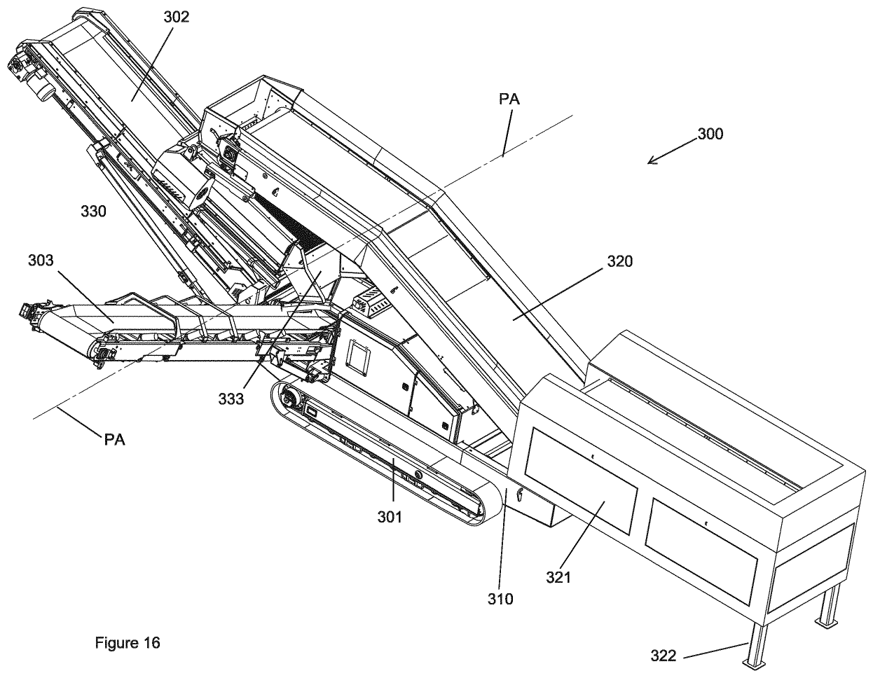

As shown in FIGS. 14a and 15a, screen 230 may be pivoted along pivot axis A such that screen 230 is angled and mounted with the inlet end of screen 230 higher than the outlet end. FIG. 14a shows screen 230 with the inlet end raised up 7 degrees such that the material remains on the screen for a shorter time and FIG. 15a shows screen 230 with the inlet end raised up 3 degrees such that the material remains on the screen for longer.

FIGS. 14b and 15b, respectively, show the flow F of material within the screen when the screen is angled as per FIGS. 14a and 15a.

FIG. 16 shows another alternative preferred screening apparatus according to the invention, generally referred to herein by reference numeral 300. As shown, screening apparatus 300 comprises frame 310, feed conveyor 320 mounted at one end of frame 310 and screen 330 pivotally mounted on frame 310 about pivot axis PA. In the preferred embodiment shown in FIG. 16, screening apparatus 300 and further comprises tracks 301. Additionally, screening apparatus 300 further comprises conveyor 302 to collect and stockpile screened fines material and conveyor 303 to collect and stockpile screened oversize material.

Feed hopper 321 is attached to frame 310 and may be adjusted by jacking rams 322 in order to pivot screening apparatus 300 on tracks 301.

Screen 330 is identical to screen 230. As well as being open at the top for accepting waste material from conveyor 320 and open at the base to allow fine material to be discharged, screen 330 is provided with outlet 333 for discharging oversize material. Oversize outlet 333 is shown at the rear of screen 330 in FIG. 16, i.e. at the opposite end of screen 330 to conveyor 320.

Screen 330 is mounted on frame 310 such that at least a portion at least a portion of the top opening thereof is located beneath the outlet end of feed conveyor 320 and the elongate rotating members are each independently perpendicular to pivot axis PA.

In order to enable screen 330 to be removed from screening apparatus 300 for ease of maintenance of the screen, screen 330 is removably mounted to frame 310 such that screen 330 slides with respect to frame 310 for removal therefrom.

Screen 330 may be pivoted along pivot axis PA such that screen 330 is angled and mounted with the inlet end of screen 330 higher than the outlet end. FIG. 16 shows screen 330 with the inlet end raised up such that the material remains on the screen for a shorter time.

It is to be understood that the invention is not limited to the specific details described herein which are given by way of example only and that various modifications and alterations are possible without departing from the scope of the invention as defined in the appended claims.

1. A screening apparatus for screen waste material, wherein the waste material contains fine material and oversize material, said screening apparatus comprising:
a frame;
a feed conveyor mounted at one end of the frame; and
a screen for accepting the waste material from the feed conveyor,
wherein the screen is mounted on the frame about a pivot axis and comprises:
a trough with a first side, a second side, a base and a top opening; and
a plurality of driven elongate rotating members disposed in an arc along one side of the trough and along at least a portion of the base of the trough for causing circular or helical flow of the waste material within the trough, wherein each of said plurality of driven elongate rotating members has a shaft and a plurality of mutually parallel blades,
wherein the trough further comprises a base opening for discharging the fine material and an oversize material outlet for discharging the oversize material; and
wherein the screen is mounted on the frame such that the elongate rotating members are each independently perpendicular to the pivot axis.

2. The screening apparatus of claim 1, wherein the screen comprises a first plurality of driven elongate rotating members disposed in a first arc along the first side and along at least a portion of the base of the trough and a second plurality of driven elongate rotating members disposed in a second arc along the second side of the trough and along at least a portion of the base of the trough.

3. The screening apparatus of claim 2, wherein the first plurality of driven elongate rotating members is driven to run in the opposite direction to that of the second plurality of driven elongate rotating members.

4. The screening apparatus of claim 2, wherein there are at least five driven elongate rotating members disposed in the first arc.

5. (canceled)

6. The screening apparatus of claim 1, wherein each of the blades independently has a plurality of curved radial extensions which act on the waste material during the rotation thereof.

7. The screening apparatus of claim 1, wherein the screen further comprises a feed inlet for accepting the waste material from the feed conveyor such that the feed inlet is beneath the feed conveyor.

8. The screening apparatus of claim 1, further including at least one secondary screen.

9. The screening apparatus of claim 1, wherein the screening apparatus further comprises at least one conveyor to collect and stockpile the waste material that passes through the screen.

10. The screening apparatus of claim 1, wherein the oversize material outlet is disposed at an end of the trough opposite the feed conveyor.

11. The screening apparatus of claim 1, wherein the screening apparatus further comprises a ram assembly to alter the screen with respect to the frame about the pivot axis.

12. The screening apparatus of claim 1, wherein the screen is removably mounted to the screening apparatus.

13. The screening apparatus of claim 1, wherein the screen is pivotally mounted on the frame such that at least a portion of the top opening of the trough is located beneath the feed conveyor.

14. The screening apparatus of claim 1, wherein the screening apparatus further comprises a static feed plate between the feed conveyor and the screen.

15. The screening apparatus as claimed in claim 6 wherein each of the blades is manufactured from toughened steel, mild steel or hard wearing plastics such as polyurethane.

16. The screening apparatus according to claim 7, wherein the feed inlet is in the form of a chute.

17. The screening apparatus of claim 12, wherein the screen is slidably mounted to the frame to facilitate removal of the screen.

18. The screening apparatus of claim 1, wherein the feed conveyor is slidably mounted to the frame and can be selectively moved to facilitate removal of the screen.
